(19) United States
(12) Patent Application Publication
(10) Pub. No.: US 2015/0201077 A1
(43) Pub. Date: Jul. 16, 2015

(54) COMPUTING SUGGESTED ACTIONS IN CALLER AGENT PHONE CALLS BY USING REAL-TIME SPEECH ANALYTICS AND REAL-TIME DESKTOP ANALYTICS

(71) Applicant: Genesys Telecommunications Laboratories, Inc., Daly City, CA (US)

(72) Inventors: Yochai Konig, San Francisco, CA (US); Javier Villalobos, Redwood City, CA (US)

(21) Appl. No.: 14/153,049

(22) Filed: Jan. 12, 2014

(51) Int. Cl. H04M 3/51

(52) U.S. Cl. CPC H04M 3/5175; H04M 2203/401

(57) ABSTRACT

A method for generating a recommended action during a voice interaction in a contact center includes: analyzing in real time, on a computer system including a processor and memory storing instructions, audio data of the voice interaction; detecting, on the computer system, events from the audio data; identifying, on the computer system, a plurality of identified features corresponding to the detected events; supplying, on the computer system, the identified features to a statistical model; and identifying, on the computer system and using the statistical model and the identified features, the recommended action from a plurality of actions.

### FIELD

Embodiments of the present invention relate to the field of real-time speech analytics. In particular, some embodiments of the present invention are directed to providing systems and methods for providing instructions and recommendations in real-time in based on an automatic analysis of captured speech information.

### BACKGROUND

Various organizations and enterprises often interact with their customers (or potential customers) via human agents employed by the organization. Such interactions may occur over the telephone, via Internet Protocol telephony systems (e.g., voice over IP or VoIP), via Internet-based voice communications systems (e.g., Google® Hangouts or Skype®), via web based chat voice chat systems (e.g., WebRTC), or via text-based chat and email.

Such interactions may often include sales activities. These activities can happen during in-bound sales calls when the customer calls a company with an interest in one or more of their offerings (for example, as a result of a targeted marketing campaign or as a response to an advertisement). These activities may also occur during out-bound calls from the company to its customers or when cold calling to potential customers.

In order to increase sales conversions, organizations seek ways to increase or maximize the expected value of each sales opportunity. This can include identifying an effective or optimal combination of sales skills or techniques (sometimes referred to as a “Golden Sales recipe”), making sure that their agents are utilizing effective sales skills, and finding the best product to pitch in any given situation.

### SUMMARY

Aspects of embodiments of the present invention are directed to automatically generating recommended actions for an agent to take and recommended offers for the agent to make to a customer during a voice (spoken) interaction. Statistical models compute the recommended actions and recommended offers based on information about the progress of the current voice interaction and based on explicitly known customer profile information, such as information stored in a customer profile database.

Aspects of embodiments of the present invention are also directed to automatically generating statistical models for generating the recommended actions and offers, where the statistical models are generated from previous call information, known customer profile information, and information about the result of the interaction.

According to one embodiment of the present invention, a method for generating a recommended action during a voice interaction in a contact center includes: analyzing in real time, on a computer system including a processor and memory storing instructions, audio data of the voice interaction; detecting, on the computer system, events from the audio data; identifying, on the computer system, a plurality of identified features corresponding to the detected events; supplying, on the computer system, the identified features to a statistical model; and identifying, on the computer system and using the statistical model and the identified features, the recommended action from a plurality of actions.

The identified features may further include features corresponding to customer profile information.

The analyzing the audio data may include automatically detecting spoken phrases within the audio using an automatic speech recognition engine.

The recommended action may include an offer of a particular product of a plurality of products.

The statistical model may include a trained neural network.

The trained neural network may begenerated using a collection of historical sales interactions by: performing, on the computer system, automatic speech recognition on the collection of historical sales interactions; detecting, on the computer system, historical events within the collection of historical sales interactions; determining, on the computer system, historical sales results of the historical sales interactions; and training the trained neural network using the historical events and the historical sales results.

The trained neural network may be a multilayer perceptron neural network and wherein the neural network is trained by applying a backpropagation algorithm.

The statistical model may include a plurality of product statistical models, each product statistical model being configured to compute, based on the identified features, a probability of selling a corresponding product of a plurality of products, and the identifying the recommended action may include: supplying the identified features to each of the product statistical models of the statistical model to compute a plurality of probabilities corresponding to the products; multiplying each of the computed probabilities by a corresponding product profit margin to compute expected values; and identifying the recommended action in accordance with the expected values.

The identifying the recommended action may include: returning a recommended action of not offering any product when all of the expected values are below a threshold value; and returning an identified product of a plurality of products, the identified product corresponding to a largest expected value of the expected values when not all of the expected values are below the threshold value.

According to one embodiment of the present invention, a method for guiding an agent in a call center through an effective sequence of sales skills during a speech interaction includes: identifying, on a computer system including a processor and memory, a first sales skill of the sequence of sales skills, each of the sales skills comprising a plurality of corresponding phrases; processing, on the computer system, the speech interaction to detect a plurality of spoken phrases; matching, on the computer system, a first spoken phrase of the spoken phrases with a corresponding phrase of the corresponding phrases of the first sales skill; and identifying, on the computer system, a second sales skill of the sequence of sales skills after matching the first spoken phrase with the corresponding phrase of the first sales skill.

According to one embodiment of the present invention, a method for generating an effective sequence of sales skills for an agent to utilize during an interaction includes: applying, on a computer system including a processor and memory, a feature selection process to identify features from a plurality of feature vectors corresponding to a collection of successful historical interactions; selecting, on the computer system, effective sales skills from the identified features; and determining, on the computer system, an effective order of the effective sales skills.

According to one embodiment of the present invention, a system includes: a processor; and memory storing instructions configured to control the processor to: recognize in real time a plurality of spoken phrases in a voice interaction; detect a plurality of events from the spoken phrases; identify a plurality of identified features corresponding to the detected events; supply the identified features to a statistical model; and identify, using the statistical model and the identified features, a recommended action from a plurality of actions.

The identified features may further include features corresponding to customer profile information.

The recommended action may include an offer of a particular product of a plurality of products.

The statistical model may include a trained neural network.

The system may be configured to generate the trained neural network using a collection of historical sales interactions by: performing automatic speech recognition on the collection of historical sales interactions; detecting historical events within the collection of historical sales interactions; determining historical sales results of the historical sales interactions; and training the trained neural network using the historical events and the historical sales results.

The trained neural network may be a multilayer perceptron neural network and wherein the neural network is trained by applying a backpropagation algorithm.

The statistical model may include a plurality of product statistical models, each product statistical model being configured to compute, based on the identified features, a probability of selling a corresponding product of a plurality of products, and the system may be configured to identify the recommended action by: supplying the identified features to each of the product statistical models of the statistical model to compute a plurality of probabilities corresponding to the products; multiplying each of the computed probabilities by a corresponding product profit margin to compute expected values; and identifying the recommended action in accordance with the expected values.

The generating the recommended action may include: returning a recommended action of not offering any product when all of the expected values are below a threshold value; and returning an identified product of a plurality of products, the identified product corresponding to a largest expected value of the expected values when not all of the expected values are below the threshold value.

### BRIEF DESCRIPTION OF THE DRAWINGS

FIG. 1 is a block diagram illustrating a system for computing a recommended action in a call center according to one embodiment of the present invention.

FIG. 2 is a flowchart illustrating a method for training a statistical model according to one embodiment of the present invention, where the statistical model is used to calculate the probability that a given interaction will result in a sale of a product.

FIG. 3 is a flowchart illustrating a method for computing a set of effective sales skills for a product according to one embodiment of the invention.

FIG. 4 is a flowchart illustrating a method 400 for identifying a recommended sales offer in accordance with one embodiment of the present invention.

FIG. 5 is a flowchart illustrating a method for guiding an agent through a sequence of effective sales skills according to one embodiment of the present invention.

FIG. 6 is a schematic block diagram of a system supporting a contact center that is configured to provide access to recorded audio conversations according to one exemplary embodiment of the invention.

FIG. 7A is a block diagram of a computing device according to an embodiment of the present invention.

FIG. 7B is a block diagram of a computing device according to an embodiment of the present invention.

FIG. 7C is a block diagram of a computing device according to an embodiment of the present invention.

FIG. 7D is a block diagram of a computing device according to an embodiment of the present invention.

FIG. 7E is a block diagram of a network environment including several computing devices according to an embodiment of the present invention.

### DETAILED DESCRIPTION

Aspects of embodiments of the present invention are directed to automatically coaching and suggesting actions to an agent in real-time during an interaction with a customer. This coaching and the suggested actions to provide the agent with particular sales skills or techniques to use and/or the content of the predicted best (or “optimal”) offer for a given situation by automatically and dynamically performing real-time speech analytics on the audio of the interaction and real-time desktop analytics on the agent's activity on his or her agent terminal (or computer). The automatic coaching and suggested actions be used to increase up-sales, cross-sales, and sales conversions by recommending steps that, according to past data, have high likelihood of success.

Comparative techniques focus on performing off-line analytics based on historical calls, and offline training of agents (e.g., during staged or classroom based training sessions rather than live calls) on a script that is manually created based on the successful sales techniques manually identified based on the historical analysis. During calls, agents typically follow the script provided by the organization.

Organizations have recently started to use Real-Time Speech Analytics (e.g., the ability to perform Automatic Speech Recognition (ASR) on the live call between the agent and the caller) to provide further insight into the activities within a contact center. Desktop analytics technology provides information on the agent activity on his or her desktop such as which applications the agent has engaged, values entered into various fields, search activity, and similar information on agent behavior.

Embodiments of the present invention are directed to systems and methods for automatically providing recommendations to agents based on automatically computed successful strategies. For example, during an ongoing interaction with a customer, an embodiment of the present invention may identify a best offer for the customer given the customer's previous purchases and buying habits and based on information derived so far during the current interaction, such as the customer's current mood or stated circumstances.

For instance, during a call with an agent of an airline company, if a customer says: “I would like to fly to Utah, stay with my sister's family, and travel around the state,” then embodiments of the present invention can suggest to the agent that a car rental cross-sale would likely be successful but would not recommend attempting a cross-sell of hotel accommodations.

According to aspects of embodiments of the present invention, the statistical models used to predict the optimal sale offer are trained by automatically extracting data from a collection of call data (e.g., previously recorded interactions) and associated information about the eventual outcomes of those interactions. For example, a collection of recorded audio may be stored in a database along with information about what additional products and services were purchased by the customer during the call.

The recorded audio can be processed by an automatic speech recognition (ASR) engine and particular events can be detected within the recognition output to assign categories and topics to the call based on detected phrases. Such concepts of automatically analyzing and detecting events and categorizing calls based on detecting events can be found in, for example, “SYSTEM AND METHOD FOR DISCOVERING AND EXPLORING CONCEPTS,” U.S. patent application Ser. No. 13/952,459, filed on Jul. 26, 2013, the entire disclosure of which is incorporated herein by reference. For example, in one embodiment of the present invention, detecting the phrase “I would like to speak to your manager” causes the particular interaction to be classified or tagged with the category or topic of “customer dissatisfaction.” Each category or topic that an interaction is tagged with will be referred to herein as a “feature.” The detected features in the interactions and the eventual outcomes of the interactions can be used to train statistical models in order to generate predictions of the likelihood of reaching particular outcomes based on the presence or absence of particular features in future interactions.

Embodiments of the present invention will be described in more detail below in reference to four aspects: 1. the training of a statistical model for predicting an optimal sales offer; 2. the finding of optimal sales skills for each product and an optimal or improved order in which such sales skills occur; 3. applying the generated statistical model on live calls to suggest a predicted optimal sales offer; 4. providing real-time guidance to an agent on the best sales skills to utilize when pitching a particular sales offer and the timing of using such skills.

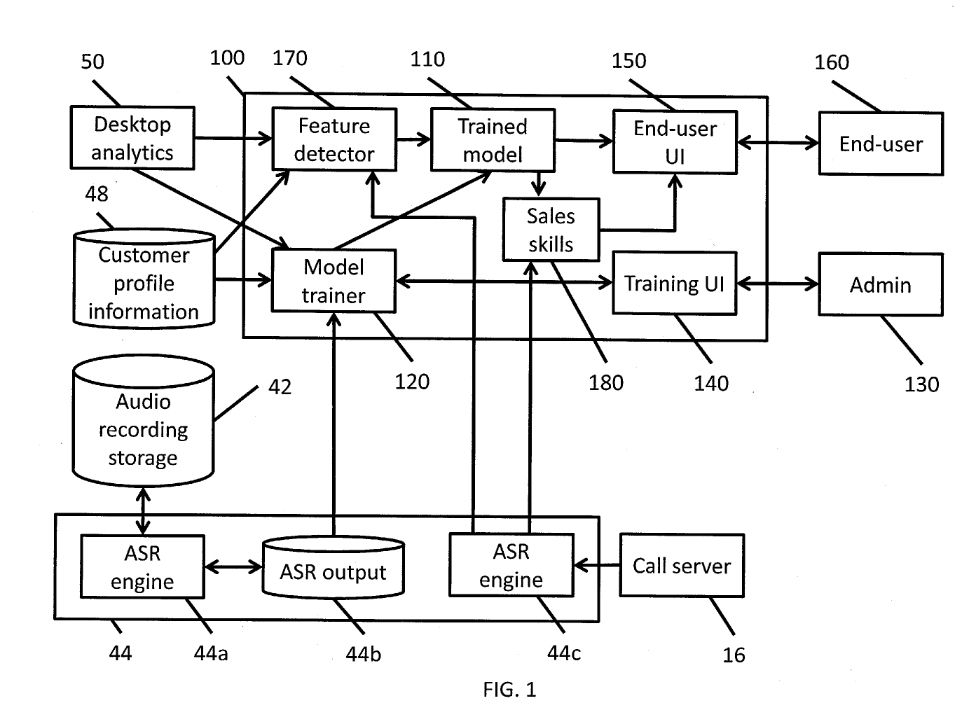

FIG. 1 is a block diagram illustrating a system 100 for computing a recommended action for an agent according to one embodiment of the present invention. The system 100 according to embodiments of the present invention includes a trained machine learning model 110 that is trained on training data by a model trainer module 120. The trained model 110 may also include a collection of trained models. The training data includes the output of an automatic speech recognition engine 44a, where the output of the automatic speech recognition engine may be stored in an ASR output database 44b. In one embodiment, the training data also includes customer profile information 48, which includes historical information about calls individual customers and contact centers, the resulting sales (if any) associated with the call, and other profile information about the customer (e.g., geographic location, preferences, purchase history, employer, etc.).

A training user interface 140 can be used to edit the parameters of the model trainer 120 and to edit the trained model 110.

The automatic speech recognition engine 44a and the ASR output database 44b may be components of a speech analytics module 44. The ASR engine 44a is configured to process recorded audio stored in an audio recording storage server 42 (e.g., digital audio files stored in a format such as PCM, WAV, AIFF, MP3, FLAC, OGG Vorbis, etc.) to recognize spoken words (e.g., speech) stored in the recoded audio. In some embodiments, the ASR engine 44a is configured to perform real-time analysis of audio. The recognized data is stored in the ASR output database 44b.

In one embodiment, real-time speech (audio) received from a call server 16 is processed in real-time by a real-time ASR engine 44c. In some embodiments, the real-time ASR engine 44c is the same as ASR engine 44a. In other embodiments, the real-time ASR engine 44c is a separate server.

In one embodiment, the output of the real-time ASR engine 44c is supplied to a feature detector 170 along with the real-type output of the desktop analytics engine 50 and data from the customer profile information database 48. The feature detector 170 generates a feature vector from the supplied data representing an ongoing interaction (or “call”) and supplies the feature vector to the trained model 110. The trained model 110 computes suggested actions based on the supplied feature vector and outputs the computed suggested actions to an end user 160 through an end-user user interface 150.

### Training Statistical Models

According to one embodiment of the present invention, the trained model 110 is trained to predict a suggested or optimal sales offer based on an analysis of a conversation and information known about the caller. The analysis of the conversation can include speech and desktop analytics and the information about the caller can include customer profile information and information about previous transactions with the customer.

According to one embodiment, the optimal sales offer is selected based on the offer that maximizes the expected value of monetary profit. Equation 1 is one equation for evaluating the expected value of a product:

arg max Profit(X)=P_{X}(call)*margin(X)
X∈Products
Equation 1—Maximize expected value of Profit where margin(X) is the profit from selling product X and P_{X}(call) is the probability that the customer will buy product X during the given call.

In order to estimate the value of P_{X}(call) for any particular product, according to one embodiment of the present invention, the trained statistical model 110 computes, for each product X, the probability that a customer will buy that product X given the analysis of the call thus far and the information known about the customer.

For example, in one embodiment, the statistical model takes into account the entire known context on the caller such as customer status, recent transaction and interaction history, prior purchases on the phone with the dynamic information that the customer expressed in the call with the agent. The dynamic information includes general statements about his or her overall sentiment at the moment such as “I'm really happy with your service” or “I'm completely dissatisfied with your latest product” and more specific buying signals such as “I'm routinely charged for going over my minutes” or “My son just turned 16” (which, for example, would make him eligible to drive a car in case the customer is speaking to an insurance company agent).

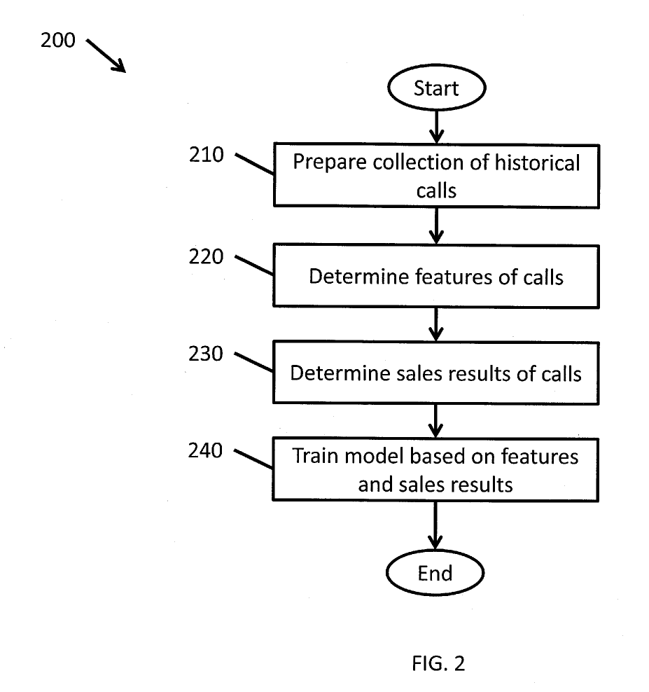

Referring to FIG. 2, to train such a statistical model, in one embodiment of the present invention, in operation 210 the model trainer 120 prepares a collection (e.g., a database) of successful and unsuccessful sales interactions (or “calls”) for analysis. Each historical call record (e.g., stored in audio recording storage 42 and/or ASR output 44b) is used to prepare an input feature vector call.

In one embodiment, the input features are pre-defined categories found based on performing speech analytics on the historical call 42. More generally, in operation 220, the model trainer 120 detects agent sales skills, customer product needs, customer call and other categories by looking for specific spoken phrases within the output of the automatic speech recognition system. See, for example, U.S. Pat. No. 7,487,094, “System and method of call classification with context modeling based on composite words,” the entire disclosure of which is incorporated herein by reference.

As described above, each “category” can be defined as a collection of phrases. For example, if the caller says “Where's my order?” the call is classified as belongs to the “where's my stuff?” category. Similarly a call can be classified as “unresolved” if the customer utters phrases such as “This is not solving my question” or “I'll call again later”.

According to one embodiment, the output target for a given historical call is a binary indication of “sales success,” as detected from the sales records in the customer profile information database 48. For example, a value of 1 can indicate that the call resulted in the sale of a particular product and 0 if the call did not result in a sale. In operation 230, the model trainer 120 matches product sales information from the customer profile information database 48 to determine whether a given call resulted in the sale of a particular product.

Accordingly, in one embodiment of the present invention, the input features of a historical call can expressed as a vector of categories, where a value of 1 indicates that the call matched with a particular category and 0 indicates that the call did not match with that category, e.g.:

Callᵢ[Category₁Category₂ . . . Category_{N}][Sales_Success]

where Categoryⱼ has a value of 1 if a phrase matching Category found in Call, and Sales_Success has a value of 1 if the operation resulted in the sale of a given product and 0 if it did not. A separate vector can be generated for each product offered by the organization.

In addition to phrases detected within calls, categories can also correspond to events found by real-time desktop analytics engine 50 (such as the OpenSpan® Desktop Analytics™ Engine), information known about the caller (e.g., customer profile, previous transactions, etc.) stored in the customer profile information database 48. For instance, known information about whether a customer has credit score over 700 can be identified in the feature vector with a “1” for “yes” and “0” for “no.” The input vector can also include timing information about skills such as detecting a phrase in the “building rapport” phrase category with the first 90 seconds of the sales pitch or “creating urgency” during in the last minute of the sales pitch.

Once the training data has been prepared as described above (e.g., converting detected events and customer information into feature vectors), the model trainer 120 uses the collection of feature vectors (e.g., the vectors of categories found in the calls) and the target values (e.g., the sales_success values of the calls) to train a statistical model for the given product in operation 240.

According to one embodiment of the present invention, an artificial neural network is used as the trained statistical model. More information on neural networks, is found, for example, in I. A. Basheer and M. Hajmeer. Artificial neural networks: fundamentals, computing, design, and application, JOURNAL OF MICROBIOLOGICAL METHODS 43 (2000) 3-31, the content of which is incorporated herein by reference.

According to one embodiment of the present invention, a multi-layer perceptron (MLP) is used as the neural network, where the neural network includes x input neurons in the input layer, y hidden layers, and one neuron in the output layer. The input vectors of the calls in the collection of historical calls are supplied as the input feature vector to the input layer of the neural network and the result value in the output neuron corresponds to the target value for the given call.

According to one embodiment of the present invention, the training data is divided into a train set, a test set, and a development set. The neural network was trained on the train set using the back-propagation algorithm, with stopping criteria determined by the development set. When the trained neural network receives a feature vector, it outputs a value v, such as, for example, a value between 0 and 1.

According to one embodiment, the model 110 includes a neural network (NN). In operation 240, the model trainer 120 is configured to attempt to generate a model 110 that approximates the output of the target function P_{X}(call) on the features of a call (target values) when the target values are supplied with the training phrases, where the target function P_{X}(call) output represents a measure of the probability that the given features result in a successful sale of a given product or product category. The target function is unknown for calls (e.g., detected features, agent behavior, and customer profiles) outside of the collection of historical calls (e.g., the training data) in the sense that it is impossible to know for certain the value of the target function outputs for inputs outside of the historical calls. The model trainer 120 supplies the training data to the model 110, compares the output of the model 110 with the output of the target function P_{X}(call), and iteratively adjusts the parameters of the model 110 until the behavior of the model is determined to be sufficiently similar to the behavior of the target function P_{X}(call) (or “P_{X}(call) measure”).

Briefly, according to one embodiment, the training data is divided into a training set, a test set, and a development set. The features of each of the historical calls in the training set (which were calculated in operation 220) are supplied to the x input neurons of the input layer of the neural network. Using the back-propagation algorithm, the weights of links between x neurons in the input layer, the y hidden layers, and the one neuron in the output layer are iteratively adjusted to attempt to reach the computed target values of the training set and the process is stopped when the improvement of the performance on the development set is lower than a threshold value (e.g., a defined threshold value). The resulting model is then validated against the test set. However, in other embodiments of the present invention, the parameters of the training of the neural network can be set differently.

The result of the training is a set of statistical models that, for each product (or product categories) predicts P_{X}(call) for a given product as described above, given a particular input vector of categories associated with a call, where P_{X}(call) identifies the probability of selling product X during a call, where call is an input vector (or collection of identified features of) the call.

### Identifying Optimal Sales Skills for Each Sales Offer

Generally, agents working in sales and other departments within an organization's contact center follow a script that is designed to increase the likelihood of sales. For example, a standard sales script may include an introduction, an explanation of service capabilities, a final pitch, a request for payment information, a closing portion, building rapport, rebuttals to customer concerns, etc. However, such sales scripts are typically rigid in design and somewhat limited in ability to adapt to a wide range of circumstances.

Embodiments of the present invention are directed to systems and methods capable of analytically, automatically, and systematically finding the effective sales skills for each product (or a “golden sales recipe”) and guiding an agent during the live call to effectively utilize these sales skills. In addition, embodiments of the present invention are directed to determining effective ordering and timing of these sales skills during a call. For example, an “offer description” generally should come before “asking for sales.”

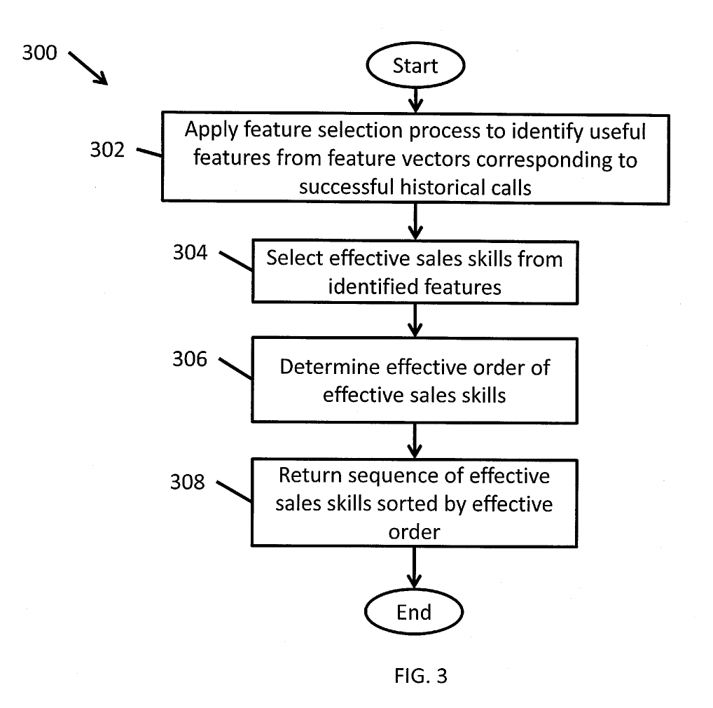

FIG. 3 is a flowchart illustrating a method for computing a set of effective sales skills for a product according to one embodiment of the invention.

According to one embodiment, as described above, for a given product or product category, a collection or database of successful and unsuccessful calls related to each product or product category was assembled, where each call is represented by a vector of categories along with a sales_success value:

Callᵢ[Category₁Category₂ . . . Category_{N}][Sales_Success]

where Category₁ has a value of 1 if the Category₁ was found in Callᵢ and a value of 0 otherwise and Sales_Success is 1 if Callᵢ resulted in a successful sale (or was a successful sales call) and 0 otherwise. The categories in this database are possible sales elements and sales skills that the agent can utilize. According to one embodiment of the present invention, in operations 302 and 304, the model trainer 120 applies a feature selection process such as mutual information, correlation techniques, or regression analysis (see, e.g., Gelman and Hill, Data Analysis Using Regression and Multilevel/Hierarchical Models (2006)) is applied to determine which of the input variables (e.g., [Category₁ Category₂ . . . Category_{N}] are most useful for estimating the value of the output variable. This process will be referred to herein as selecting effective sales skills. In one embodiment, six to eight effective sales skills reflects a practical number of sales skills to use.

After selecting a set of effective sales skills, according to one embodiment of the present invention, model trainer 120 determines, in operation 306, an effective order of the sales skills during a sales call and the computed effective order of effective sales skills is returned in operation 308.

According to one embodiment of the present invention, to compute the effective order of effective skills in operation 306, a collection (or database) of all the successful sales calls containing the skills is generated with timing information of each of the skills. For example, one row of such a database may read:

Sales_Skill₁1:02 Sales_Skill₂1:45 . . . Sales_Skillₖ:2:33

where, for example, Sales_Skill₁ 1:02 means that, one minute and two seconds into the call, the agent started to utilize Sales_Skill₁. After we have created the database, the model trainer 120 applies machine learning algorithms to infer the ideal ordering of the sales skills. A description of a variety of algorithms for computing (or deducing) such an ordering can be found, for instance, in chapter 4 of “INDUCING EVENT SCHEMAS AND THEIR PARTICIPANTS FROM UNLABELED TEXT,” Nathanael William Chambers, Ph. D thesis, Stanford University, 2011, the entire disclosure of chapter 4 of which is incorporated herein by reference. In one embodiment of the present invention, the “Global Model” algorithm described on page 71 of “INDUCING EVENT SCHEMAS AND THEIR PARTICIPANTS FROM UNLABELED TEXT” is used to compute the ordering. The computed effective order of effective sales skills is returned in operation 308 as a sequence of sales skills.

According to one embodiment, the sequences of effective sales skills can be computed offline (e.g., computed based on analyzing a large collection of historical calls, not in real-time) and the resulting sequences of sales skills can be stored in a database on a product-by-product basis. As such, the system 100 can retrieve the computed sequence of effective sales skills from the database as needed.

The process can be repeated for every product offered by the organization. The inferred ideal ordering of sales skills for each product or product category corresponds to the automatically derived “golden sales recipe” for each product or product category.

### Applying the Statistical Models to Live Calls to Suggest Recommended or Optimal Sales Offers

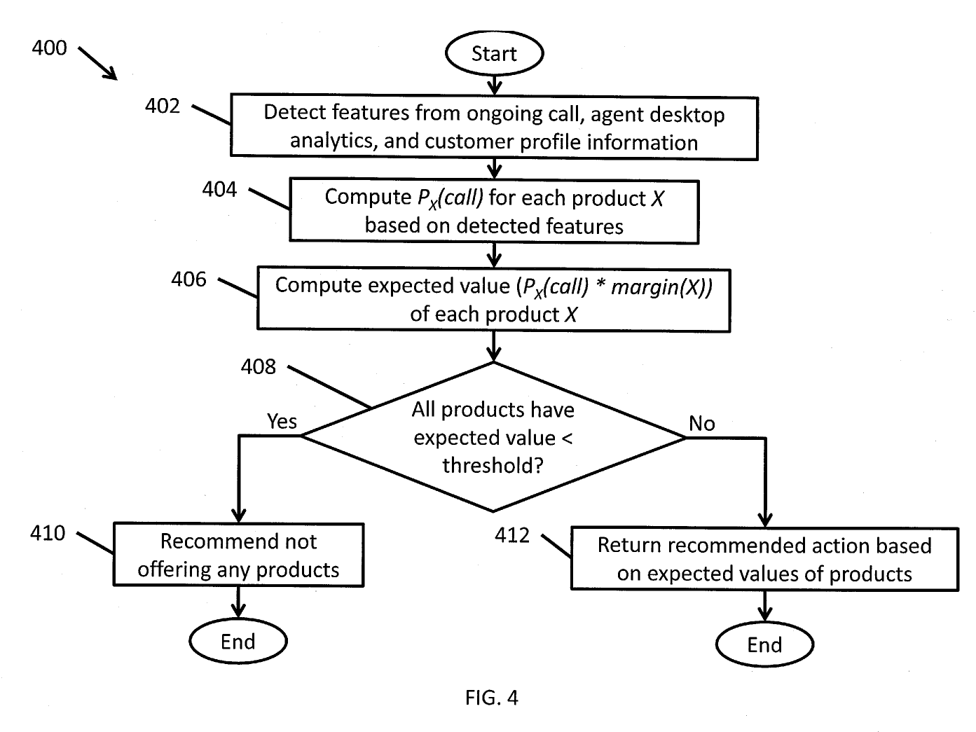

The statistical models developed for each of the products and product categories can be used to evaluate P_{X}(call) for each product X as described above. FIG. 4 is a flowchart illustrating a method 400 for identifying a recommended sales offer in accordance with one embodiment of the present invention.

As discussed above, if a customer says something like “I'm being charged on my text messages,” embodiments of the present invention can detect this phrase and identify that offering a “data plan” would likely result in a sale and would recommend that the agent “suggest a data plan” to sell the customer on a service that will resolve his or her problem.

As another example, the system can detect a customer saying: “My two sons watch movies on the Internet—I'm not sure that 1 can do my work at the same time” and the system might guide the agent to offer an Internet package with higher bandwidth as an up sell offer. As still another example, the system may detect the customer say, while speaking with an insurance agent, “I just got a new appraisal on my house and it is over a million dollars”, the system may suggest that the customer may be receptive to an offer of umbrella insurance.

According to one embodiment in operation 402, the real-time ASR engine 44c analyzes data received from the call server 16 and supplies the audio output in real time to the feature detector 170. Features within the audio (e.g., phrases belonging to particular categories) are detected by the feature detector 170 as described above. The feature detector 170 can also be supplied with real time desktop analytics from an agent's computer terminal from the desktop analytics module 50. In addition, customer profile information 48 can be supplied to the feature detector. The feature detector 170 combines the received data to generate a feature vector representing the ongoing call to be supplied as input to the trained model 110.

According to one embodiment of the present invention, the feature detector 170 is triggered to generate the feature vector and to supply the feature vector to the trained model when it receives a command from the end-user UI 150. For example, during a call with a customer, an agent may click a button or activate some other element in the user interface to request that the system compute a recommended action (e.g., a product to offer) based on the content of the call up until that point.

According to another embodiment of the present invention, the system 100 periodically and automatically generates the feature vector using the feature detector 170 and automatically updates the end-user UI 150 to show the currently recommended action. For example, the system 100 may be configured to generate the feature vector and to compute the recommended action every 15 seconds, every 30 seconds, every 1 minute, or any other time increment. In still another embodiment, the system 100 may be configured to continually generate the feature vector on an event basis (e.g., whenever new data is received from the real-time ASR engine 44c, the desktop analytics 50, and the customer profile information 48) and to compute the recommended product (or action) using the trained model 110 every time the feature vector changes due to, for example, a detected event.

In yet another embodiment, the system 100 automatically presents a recommended product or action during the call if the estimated profit (or value) for the recommended product or action is higher than a triggering threshold profit level. For example, the system 100 may periodically evaluate the expected values associated with each of the products and automatically display to the agent products having values that exceed the triggering threshold profit level.

The statistical models in the trained model 110 that are trained for each given product are supplied with the generated feature vector of events detected in real-time during the ongoing call. In operation 404, the trained model 110 the probabilities that the given events will result in a sale of the corresponding products using the statistical models. As the call progresses, the input vector of events changes and can be supplied to the statistical models to update the estimated probability that the current call will result in a sale of a given product.

According to one embodiment of the present invention, in operation 406 the expected value of every potential offer is computed by multiplying the computed probabilities with the known margin of each product.

According to one embodiment, in operation 408 the trained model 110 determines whether all of the products have an expected value less than a threshold value (or “threshold minimum profit). If so, then in operation 410 the trained model 110 recommends that the agent not offer any product and end the call. Intuitively, the idea is that, if the call is not progressing well and the customer is not interested in any of the products or product categories offered by the organization, the agent should terminate the call to avoid wasting additional time.

More specifically, if there is no product where the expected profit according to equation 1 is greater than the threshold minimum profit (Tₘᵢₙ_{_{—}}_{profB}), then, according to one embodiment of the present invention, the system guides the agent to not offer any product and simply finish the call as cost of the agent time is more than the potential profit. In another embodiment, the threshold can be set dynamically as a function of the number of callers waiting, average wait time, the time spent on the call thus far, and other factors. For instance, if the customer says “Until you solve the reception issue in my geographic area, I'm not going to buy anything from your company,” then the system may determine that it is not worth the agent's time to try to convince the customer otherwise.

On the other hand, if at least one product has an expected value greater than the threshold value, then in operation 412 the trained model generates a recommendation based on the calculated expected values of the products and returns the recommendation. For example, in one embodiment, the recommend action would be for the agent to offer the product having the highest expected value. In another embodiment, the trained model 110 returns a list of products exceeding the threshold, where the list is sorted by expected value. According to still another embodiment, the complete list of products, including those having expected value below the threshold, is returned in order of expected value.

As such, by computing the expected profit every product X(e.g., P_{X}(call)*margin(X)), the trained model can generate a recommended action for the agent to take, thereby allowing an agent to choose to focus his or her sales efforts on the predicted most valuable products. (For example, if a customer signing up for cellular phone service mentions “I have two teenage kids,” then the P_{X}(call) for a cellular family plan may increase and the system may recommend that the agent attempt an upsell on such a family plan.) In other embodiments of the present invention, different metrics may be used. For example, in one embodiment, an expected revenue (e.g., P_{X}(call)*revenue(X)) is used instead of expected profit.

According to one embodiment, this recommended action is presented to the user 160 via the end-user user interface 150.

### Applying the Derived Golden Sales Recipes to Provide Guidance on Pitching Particular Products

After determining which product to sell during the call, according to one embodiment of the present invention, the system further provides the agent with recommended effective sales skills to guide the agent during the sales process. According to one embodiment, a sales skills module 180 retrieves the sequence of effective sales skills for the identified product from the database of sales skills that were computed offline.

After identifying a product to sell, a system according to embodiments of the present invention can also guide an agent through the calculated sequence of effective sales skills to sell the product. For example, a system can first guide the agent to utilize the “Value Statement” skill (e.g., “our travel tool is the only one in the industry . . . .”) by displaying on the agent's user interface 150 the sales skill or the words to be spoken. The system actively recognizes phrases within the spoken conversation between the agent and the customer in real-time and identifies topics based on the recognized phrases (e.g., “Mr. Lee, you will be flying from SFO to LHR on . . . .” may be recognized as an “air reservation” topic). When the system automatically detects the use of a sales skill, then system prompts the agent to proceed to the next skill. For example, the system may then guide the agent to confirm the customer itinerary and then note an upsell opportunity and provide customized offers of travel package deals to the agent. The agent can then present the deal package to the customer (e.g. “Mr. Lee, I have a great package offer for you.”). The system can automatically monitor the progress of each step of the agent's sales pitch by automatically recognizing the agent's speech in real-time.

As another example, if the sales skills order for a particular product is:
[building rapport, product description, create urgency, ask for sale]
   then the system can detect speech events using speech analytics. For example, after the system detects the agent's description of the product (e.g., “The umbrella insurance would cover you for . . . ”) it would then guide the agent to create urgency (e.g., “Today we have a special promotion of first month free”).

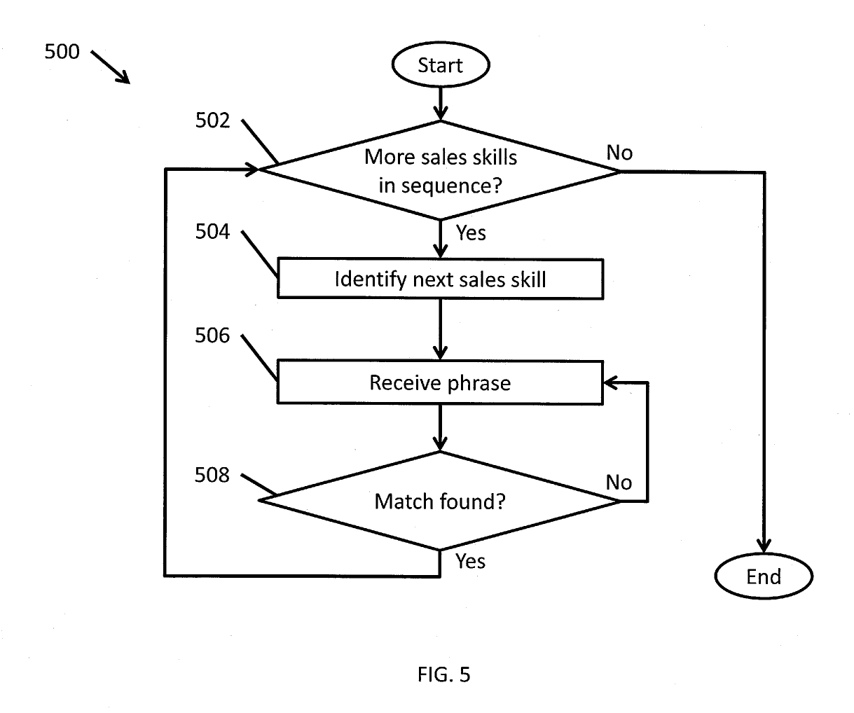

FIG. 5 is a flowchart illustrating a method for guiding an agent through a sequence of effective sales skills according to one embodiment of the present invention. The sales skills module 180 may receive the identified recommended action from the trained model 110. The sales skills module 180 may then retrieve the sequence of effective sales skills corresponding to the recommended action from the database. In operation 502, the sales skill module 180 determines if there are any more sales skills in the sequence. If so, then, in operation 504, it identifies the next sales skill of the sequence. This identified sales skill may be supplied to the end user UI 150 so that the sales skill can be displayed to the agent. In operation 506, the sales skills module 180 receives a phrase from the real-time ASR engine 44c and, in operation 508, processes the received phrase to determine whether the received phrase matches the currently identified sales skill. If there is no match, then the sales skill module 180 receives a next phrase. When a match is found, then the sales skill module 180 returns to operation 502 to determine if there are any additional sales skills in the sequence and repeats these operations for each of the sales skills in the sales skill sequence until all of the sales skills in the sequence have been matched.

For example, the first skill in the above sales skill order is “building rapport” as such, according to one embodiment of the present invention, the sales skill module 180 first identifies the “building rapport” skill from the sequence, and receive phrases from the real-time ASR engine 44c until it receives a phrase that falls within the “building rapport” category (e.g., “how's the weather in your part of the world?”). Once a corresponding sales skill is found (e.g., operation 508), then the process continues by progressing to the next skill in the sequence (here, for example, “product description”).

As such, embodiments of the present invention automatically provide real-time guidance to agents on products to offer and the order of sales skills to utilize when making the sales offer. The recommendations can be automatically generated by embodiments of the present invention by analyzing historical data to train statistical models and by analyzing the data using feature selection and ordering algorithms. The analyses provided by systems according to embodiments of the present invention can be used to improve the sales performance of agents of an organization.

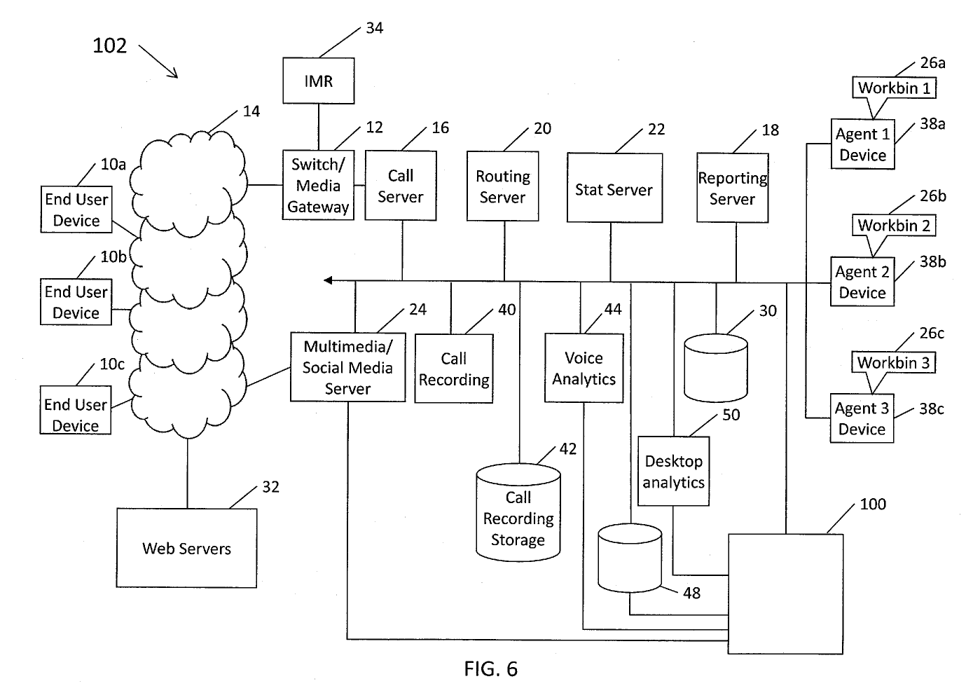

FIG. 6 is a schematic block diagram of a system supporting a contact center that is configured to provide customer availability information to customer service agents according to one exemplary embodiment of the invention. The contact center may be an in-house facility to a business or corporation for serving the enterprise in performing the functions of sales and service relative to the products and services available through the enterprise. In another aspect, the contact center may be a third-party service provider. The contact center may be deployed in equipment dedicated to the enterprise or third-party service provider, and/or deployed in a remote computing environment such as, for example, a private or public cloud environment with infrastructure for supporting multiple contact centers for multiple enterprises.

According to one exemplary embodiment, the contact center includes resources (e.g. personnel, computers, and telecommunication equipment) to enable delivery of services via telephone or other communication mechanisms. Such services may vary depending on the type of contact center, and may range from customer service to help desk, emergency response, telemarketing, order taking, and the like.

Customers, potential customers, or other end users (collectively referred to as customers) desiring to receive services from the contact center may initiate inbound calls to the contact center via their end user devices 10a-10c (collectively referenced as 10). Each of the end user devices 10 may be a communication device conventional in the art, such as, for example, a telephone, wireless phone, smart phone, personal computer, electronic tablet, and/or the like. Users operating the end user devices 10 may initiate, manage, and respond to telephone calls, emails, chats, text messaging, web-browsing sessions, and other multi-media transactions.

Inbound and outbound calls from and to the end users devices 10 may traverse a telephone, cellular, and/or data communication network 14 depending on the type of device that is being used. For example, the communications network 14 may include a private or public switched telephone network (PSTN), local area network (LAN), private wide area network (WAN), and/or public wide area network such as, for example, the Internet. The communications network 14 may also include a wireless carrier network including a code division multiple access (CDMA) network, global system for mobile communications (GSM) network, and/or any 3G or 4G network conventional in the art.

According to one exemplary embodiment, the contact center includes a switch/media gateway 12 coupled to the communications network 14 for receiving and transmitting calls between end users and the contact center. The switch/media gateway 12 may include a telephony switch configured to function as a central switch for agent level routing within the center. In this regard, the switch 12 may include an automatic call distributor, a private branch exchange (PBX), an IP-based software switch, and/or any other switch configured to receive Internet-sourced calls and/or telephone network-sourced calls. According to one exemplary embodiment of the invention, the switch is coupled to a call server 18 which may, for example, serve as an adapter or interface between the switch and the remainder of the routing, monitoring, and other call-handling components of the contact center.

The contact center may also include a multimedia/social media server for engaging in media interactions other than voice interactions with the end user devices 10 and/or web servers 32. The media interactions may be related, for example, to email, vmail (voice mail through email), chat, video, text-messaging, web, social media, screen-sharing, and the like. The web servers 32 may include, for example, social interaction site hosts for a variety of known social interaction sites to which an end user may subscribe, such as, for example, Facebook, Twitter, and the like. The web servers may also provide web pages for the enterprise that is being supported by the contact center. End users may browse the web pages and get information about the enterprise's products and services. The web pages may also provide a mechanism for contacting the contact center, via, for example, web chat, voice call, email, web real time communication (WebRTC), or the like.

According to one exemplary embodiment of the invention, the switch is coupled to an interactive media response (IMR) server 34, which may also be referred to as a self-help system, virtual assistant, or the like. The IMR server 34 may be similar to an interactive voice response (IVR) server, except that the IMR server is not restricted to voice, but may cover a variety of media channels including voice. Taking voice as an example, however, the IMR server may be configured with an IMR script for querying calling customers on their needs. For example, a contact center for a bank may tell callers, via the IMR script, to “press 1” if they wish to get an account balance. If this is the case, through continued interaction with the IMR, customers may complete service without needing to speak with an agent. The IMR server 34 may also ask an open ended question such as, for example, “How can I help you?” and the customer may speak or otherwise enter a reason for contacting the contact center. The customer's response may then be used by the routing server 20 to route the call to an appropriate contact center resource.

If the call is to be routed to an agent, the call is forwarded to the call server 18 which interacts with a routing server 20 for finding an appropriate agent for processing the call. The call server 18 may be configured to process PSTN calls, VoIP calls, and the like. For example, the call server 18 may include a session initiation protocol (SIP) server for processing SIP calls. According to some exemplary embodiments, the call server 18 may, for example, extract data about the customer interaction such as the caller's telephone number, often known as the automatic number identification (ANI) number, or the customer's internet protocol (IP) address, or email address.

In some embodiments, the routing server 20 may query a customer database, which stores information about existing clients, such as contact information, service level agreement (SLA) requirements, nature of previous customer contacts and actions taken by contact center to resolve any customer issues, and the like. The database may be managed by any database management system conventional in the art, such as Oracle, IBM DB2, Microsoft SQL server, Microsoft Access, PostgreSQL, MySQL, FoxPro, and SQLite, and may be stored in a mass storage device 30. The routing server 20 may query the customer information from the customer database via an ANI or any other information collected by the IMR 34 and forwarded to the routing server by the call server 18.

Once an appropriate agent is available to handle a call, a connection is made between the caller and the agent device 38a-38c (collectively referenced as 38) of the identified agent. Collected information about the caller and/or the caller's historical information may also be provided to the agent device for aiding the agent in better servicing the call. In this regard, each agent device 38 may include a telephone adapted for regular telephone calls, VoIP calls, and the like. The agent device 38 may also include a computer for communicating with one or more servers of the contact center and performing data processing associated with contact center operations, and for interfacing with customers via voice and other multimedia communication mechanisms.

The selection of an appropriate agent for routing an inbound call may be based, for example, on a routing strategy employed by the routing server 20, and further based on information about agent availability, skills, and other routing parameters provided, for example, by a statistics server 22.

The contact center may also include a reporting server 28 configured to generate reports from data aggregated by the statistics server 22. Such reports may include near real-time reports or historical reports concerning the state of resources, such as, for example, average waiting time, abandonment rate, agent occupancy, and the like. The reports may be generated automatically or in response to specific requests from a requestor (e.g. agent/administrator, contact center application, and/or the like).

According to one exemplary embodiment of the invention, the routing server 20 is enhanced with functionality for managing back-office/offline activities that are assigned to the agents. Such activities may include, for example, responding to emails, responding to letters, attending training seminars, or any other activity that does not entail real time communication with a customer. Once assigned to an agent, an activity an activity may be pushed to the agent, or may appear in the agent's workbin 26a-26c (collectively referenced as 26) as a task to be completed by the agent. The agent's workbin may be implemented via any data structure conventional in the art, such as, for example, a linked list, array, and/or the like. The workbin may be maintained, for example, in buffer memory of each agent device 38.

According to one exemplary embodiment of the invention, the mass storage device(s) 30 may store one or more databases relating to agent data (e.g. agent profiles, schedules, etc.), customer data (e.g. customer profiles), interaction data (e.g. details of each interaction with a customer, including reason for the interaction, disposition data, time on hold, handle time, etc.), and the like. According to one embodiment, some of the data (e.g. customer profile data) may be provided by a third party database such as, for example, a third party customer relations management (CRM) database. The mass storage device may take form of a hard disk or disk array as is conventional in the art.

The call center 102 may further include the previously described call recording server 40, the call recording storage module 42, voice analytics server 44, call success information 48, and desktop analytics server 50.

The various servers of FIG. 6 may each include one or more processors executing computer program instructions and interacting with other system components for performing the various functionalities described herein. The computer program instructions are stored in a memory implemented using a standard memory device, such as, for example, a random access memory (RAM). The computer program instructions may also be stored in other non-transitory computer readable media such as, for example, a CD-ROM, flash drive, or the like. Also, although the functionality of each of the servers is described as being provided by the particular server, a person of skill in the art should recognize that the functionality of various servers may be combined or integrated into a single server, or the functionality of a particular server may be distributed across one or more other servers without departing from the scope of the embodiments of the present invention.

In the various embodiments, the term interaction is used generally to refer to any real-time and non-real time interaction that uses any communication channel including, without limitation telephony calls (PSTN or VoIP calls), emails, vmails (voice mail through email), video, chat, screen-sharing, text messages, social media messages, web real-time communication (e.g. WebRTC calls), and the like.

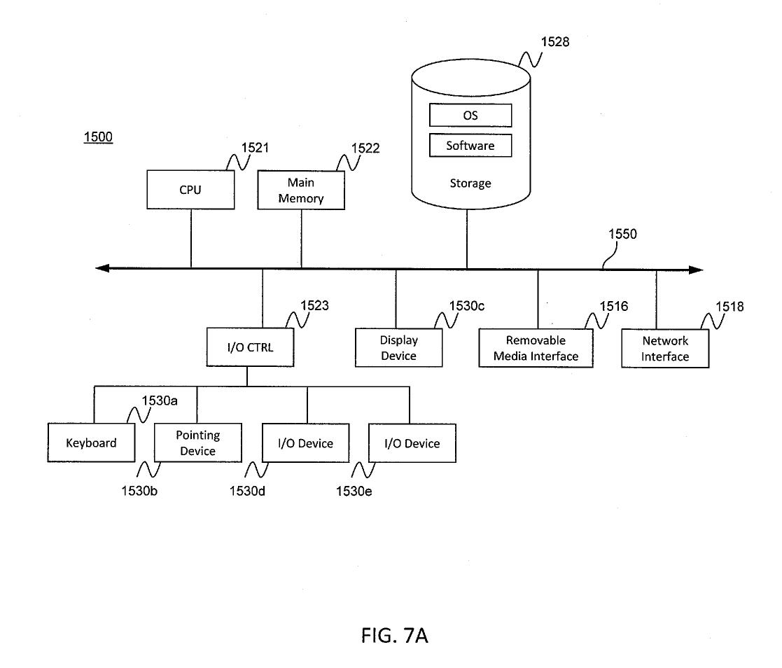

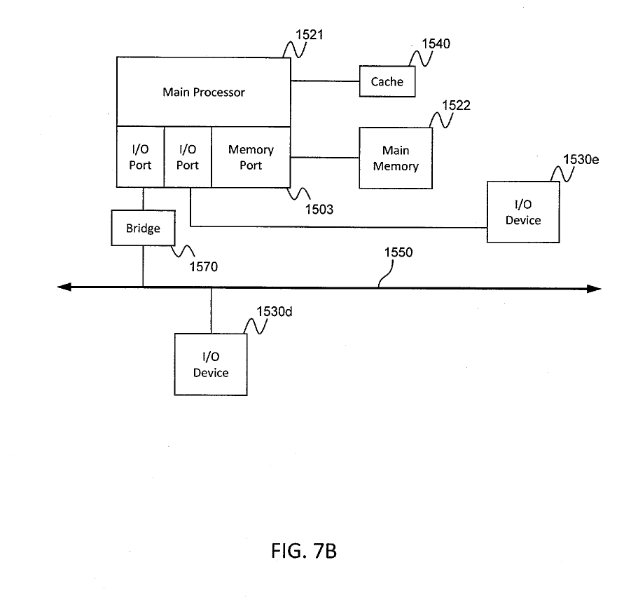

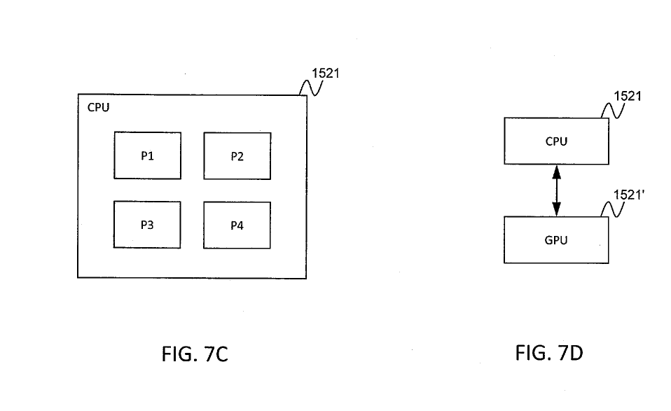

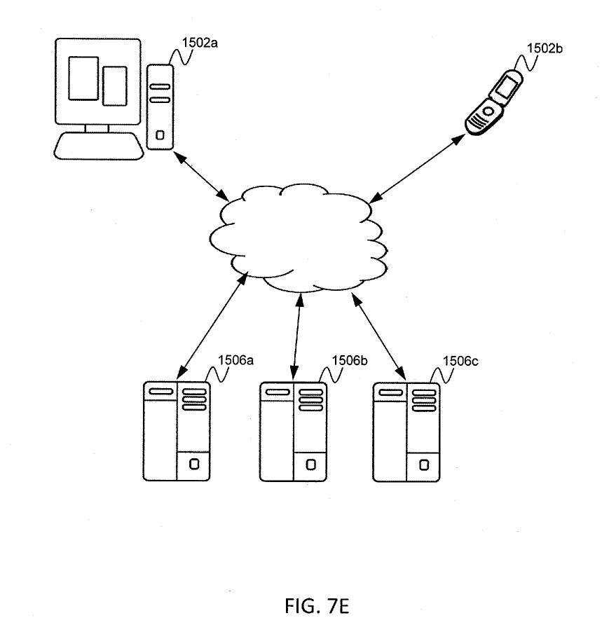

Each of the various servers in the contact center may be a process or thread, running on one or more processors, in one or more computing devices 500 (e.g., FIG. 7A, FIG. 7B), executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that a computing device may be implemented via firmware (e.g. an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the exemplary embodiments of the present invention. A server may be a software module, which may also simply be referred to as a module. The set of modules in the contact center may include servers and other modules.

Each of the various servers, controllers, switches, and/or gateways in the afore-described figures may be a process or thread, running on one or more processors, in one or more computing devices 1500 (e.g., FIG. 7A, FIG. 7B), executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that a computing device may be implemented via firmware (e.g. an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the exemplary embodiments of the present invention. A server may be a software module, which may also simply be referred to as a module. The set of modules in the contact center may include servers, and other modules.

FIG. 7A and FIG. 7B depict block diagrams of a computing device 1500 as may be employed in exemplary embodiments of the present invention. Each computing device 1500 includes a central processing unit 1521 and a main memory unit 1522. As shown in FIG. 7A, the computing device 1500 may also include a storage device 1528, a removable media interface 1516, a network interface 1518, an input/output (I/O) controller 1523, one or more display devices 1530c, a keyboard 1530a and a pointing device 1530b, such as a mouse. The storage device 1528 may include, without limitation, storage for an operating system and software. As shown in FIG. 7B, each computing device 1500 may also include additional optional elements, such as a memory port 1503, a bridge 1570, one or more additional input/output devices 1530d, 1530e and a cache memory 1540 in communication with the central processing unit 1521. The input/output devices 1530a, 1530b, 1530d, and 1530e may collectively be referred to herein using reference numeral 1530.

The central processing unit 1521 is any logic circuitry that responds to and processes instructions fetched from the main memory unit 1522. It may be implemented, for example, in an integrated circuit, in the form of a microprocessor, microcontroller, or graphics processing unit (GPU), or in a field-programmable gate array (FPGA) or application-specific integrated circuit (ASIC). The main memory unit 1522 may be one or more memory chips capable of storing data and allowing any storage location to be directly accessed by the central processing unit 1521. As shown in FIG. 7A, the central processing unit 1521 communicates with the main memory 1522 via a system bus 1550. As shown in FIG. 7B, the central processing unit 1521 may also communicate directly with the main memory 1522 via a memory port 1503.

FIG. 7B depicts an embodiment in which the central processing unit 1521 communicates directly with cache memory 1540 via a secondary bus, sometimes referred to as a backside bus. In other embodiments, the central processing unit 1521 communicates with the cache memory 1540 using the system bus 1550. The cache memory 1540 typically has a faster response time than main memory 1522. As shown in FIG. 7A, the central processing unit 1521 communicates with various I/O devices 1530 via the local system bus 1550. Various buses may be used as the local system bus 1550, including a Video Electronics Standards Association (VESA) Local bus (VLB), an Industry Standard Architecture (ISA) bus, an Extended Industry Standard Architecture (EISA) bus, a MicroChannel Architecture (MCA) bus, a Peripheral Component Interconnect (PCI) bus, a PCI Extended (PCI-X) bus, a PCI-Express bus, or a NuBus. For embodiments in which an I/O device is a display device 1530c, the central processing unit 1521 may communicate with the display device 1530c through an Advanced Graphics Port (AGP). FIG. 7B depicts an embodiment of a computer 1500 in which the central processing unit 1521 communicates directly with I/O device 1530e. FIG. 7B also depicts an embodiment in which local busses and direct communication are mixed: the central processing unit 1521 communicates with I/O device 1530d using a local system bus 1550 while communicating with I/O device 1530e directly.

A wide variety of I/O devices 1530 may be present in the computing device 1500. Input devices include one or more keyboards 1530a, mice, trackpads, trackballs, microphones, and drawing tablets. Output devices include video display devices 1530c, speakers, and printers. An I/O controller 1523, as shown in FIG. 7A, may control the I/O devices. The I/O controller may control one or more I/O devices such as a keyboard 1530a and a pointing device 1530b, e.g., a mouse or optical pen.

Referring again to FIG. 7A, the computing device 1500 may support one or more removable media interfaces 1516, such as a floppy disk drive, a CD-ROM drive, a DVD-ROM drive, tape drives of various formats, a USB port, a Secure Digital or COMPACT FLASH™ memory card port, or any other device suitable for reading data from read-only media, or for reading data from, or writing data to, read-write media. An I/O device 1530 may be a bridge between the system bus 1550 and a removable media interface 1516.

The removable media interface 1516 may for example be used for installing software and programs. The computing device 1500 may further comprise a storage device 1528, such as one or more hard disk drives or hard disk drive arrays, for storing an operating system and other related software, and for storing application software programs. Optionally, a removable media interface 1516 may also be used as the storage device. For example, the operating system and the software may be run from a bootable medium, for example, a bootable CD.

In some embodiments, the computing device 1500 may comprise or be connected to multiple display devices 1530c, which each may be of the same or different type and/or form. As such, any of the I/O devices 1530 and/or the I/O controller 1523 may comprise any type and/or form of suitable hardware, software, or combination of hardware and software to support, enable or provide for the connection to, and use of, multiple display devices 1530c by the computing device 1500. For example, the computing device 1500 may include any type and/or form of video adapter, video card, driver, and/or library to interface, communicate, connect or otherwise use the display devices 1530c. In one embodiment, a video adapter may comprise multiple connectors to interface to multiple display devices 1530c. In other embodiments, the computing device 1500 may include multiple video adapters, with each video adapter connected to one or more of the display devices 1530c. In some embodiments, any portion of the operating system of the computing device 1500 may be configured for using multiple display devices 1530c. In other embodiments, one or more of the display devices 1530c may be provided by one or more other computing devices, connected, for example, to the computing device 1500 via a network. These embodiments may include any type of software designed and constructed to use the display device of another computing device as a second display device 1530c for the computing device 1500. One of ordinary skill in the art will recognize and appreciate the various ways and embodiments that a computing device 1500 may be configured to have multiple display devices 1530c.

A computing device 1500 of the sort depicted in FIG. 7A and FIG. 7B may operate under the control of an operating system, which controls scheduling of tasks and access to system resources. The computing device 1500 may be running any operating system, any embedded operating system, any real-time operating system, any open source operating system, any proprietary operating system, any operating systems for mobile computing devices, or any other operating system capable of running on the computing device and performing the operations described herein.

The computing device 1500 may be any workstation, desktop computer, laptop or notebook computer, server machine, handheld computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 1500 may have different processors, operating systems, and input devices consistent with the device.

In other embodiments the computing device 1500 is a mobile device, such as a Java-enabled cellular telephone or personal digital assistant (PDA), a smart phone, a digital audio player, or a portable media player. In some embodiments, the computing device 1500 comprises a combination of devices, such as a mobile phone combined with a digital audio player or portable media player.

As shown in FIG. 7C, the central processing unit 1521 may comprise multiple processors P1, P2, P3, P4, and may provide functionality for simultaneous execution of instructions or for simultaneous execution of one instruction on more than one piece of data. In some embodiments, the computing device 1500 may comprise a parallel processor with one or more cores. In one of these embodiments, the computing device 1500 is a shared memory parallel device, with multiple processors and/or multiple processor cores, accessing all available memory as a single global address space. In another of these embodiments, the computing device 1500 is a distributed memory parallel device with multiple processors each accessing local memory only. In still another of these embodiments, the computing device 1500 has both some memory which is shared and some memory which may only be accessed by particular processors or subsets of processors. In still even another of these embodiments, the central processing unit 1521 comprises a multicore microprocessor, which combines two or more independent processors into a single package, e.g., into a single integrated circuit (IC). In one exemplary embodiment, depicted in FIG. 7D, the computing device 1500 includes at least one central processing unit 1521 and at least one graphics processing unit 1521′.

In some embodiments, a central processing unit 1521 provides single instruction, multiple data (SIMD) functionality, e.g., execution of a single instruction simultaneously on multiple pieces of data. In other embodiments, several processors in the central processing unit 1521 may provide functionality for execution of multiple instructions simultaneously on multiple pieces of data (MIMD). In still other embodiments, the central processing unit 1521 may use any combination of SIMD and MIMD cores in a single device.

A computing device may be one of a plurality of machines connected by a network, or it may comprise a plurality of machines so connected. FIG. 7E shows an exemplary network environment. The network environment comprises one or more local machines 1502a, 1502b (also generally referred to as local machine(s) 1502, client(s) 1502, client node(s) 1502, client machine(s) 1502, client computer(s) 1502, client device(s) 1502, endpoint(s) 1502, or endpoint node(s) 1502) in communication with one or more remote machines 1506a, 1506b, 1506c (also generally referred to as server machine(s) 1506 or remote machine(s) 1506) via one or more networks 1504. In some embodiments, a local machine 1502 has the capacity to function as both a client node seeking access to resources provided by a server machine and as a server machine providing access to hosted resources for other clients 1502a, 1502b. Although only two clients 1502 and three server machines 1506 are illustrated in FIG. 7E, there may, in general, be an arbitrary number of each. The network 1504 may be a local-area network (LAN), e.g., a private network such as a company Intranet, a metropolitan area network (MAN), or a wide area network (WAN), such as the Internet, or another public network, or a combination thereof.

The computing device 1500 may include a network interface 1518 to interface to the network 1504 through a variety of connections including, but not limited to, standard telephone lines, local-area network (LAN), or wide area network (WAN) links, broadband connections, wireless connections, or a combination of any or all of the above. Connections may be established using a variety of communication protocols. In one embodiment, the computing device 1500 communicates with other computing devices 1500 via any type and/or form of gateway or tunneling protocol such as Secure Socket Layer (SSL) or Transport Layer Security (TLS). The network interface 1518 may comprise a built-in network adapter, such as a network interface card, suitable for interfacing the computing device 1500 to any type of network capable of communication and performing the operations described herein. An I/O device 1530 may be a bridge between the system bus 1550 and an external communication bus.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

1. A method for generating a recommended action during a voice interaction in a contact center, the method comprising:
analyzing in real time, on a computer system comprising a processor and memory storing instructions, audio data of the voice interaction;
detecting, on the computer system, events from the audio data;
identifying, on the computer system, a plurality of identified features corresponding to the detected events;
supplying, on the computer system, the identified features to a statistical model; and
identifying, on the computer system and using the statistical model and the identified features, the recommended action from a plurality of actions.

2. The method of claim 1, wherein the identified features further comprise features corresponding to customer profile information.

3. The method of claim 1, wherein the analyzing the audio data comprises automatically detecting spoken phrases within the audio using an automatic speech recognition engine.

4. The method of claim 1, wherein the recommended action comprises an offer of a particular product of a plurality of products.

5. The method of claim 1, wherein the statistical model comprises a trained neural network.

6. The method of claim 5, wherein the trained neural network is generated using a collection of historical sales interactions by:
performing, on the computer system, automatic speech recognition on the collection of historical sales interactions;
detecting, on the computer system, historical events within the collection of historical sales interactions;
determining, on the computer system, historical sales results of the historical sales interactions; and
training the trained neural network using the historical events and the historical sales results.

7. The method of claim 6, wherein the trained neural network is a multilayer perceptron neural network and wherein the neural network is trained by applying a backpropagation algorithm.

8. The method of claim 1, wherein the statistical model comprises a plurality of product statistical models, each product statistical model being configured to compute, based on the identified features, a probability of selling a corresponding product of a plurality of products, and
wherein the identifying the recommended action comprises:
supplying the identified features to each of the product statistical models of the statistical model to compute a plurality of probabilities corresponding to the products;
multiplying each of the computed probabilities by a corresponding product profit margin to compute expected values; and
identifying the recommended action in accordance with the expected values.

9. The method of claim 8, wherein the identifying the recommended action comprises:
returning a recommended action of not offering any product when all of the expected values are below a threshold value; and
returning an identified product of a plurality of products, the identified product corresponding to a largest expected value of the expected values when not all of the expected values are below the threshold value.

10. A method for guiding an agent in a call center through an effective sequence of sales skills during a speech interaction, the method comprising:
identifying, on a computer system comprising a processor and memory, a first sales skill of the sequence of sales skills, each of the sales skills comprising a plurality of corresponding phrases;
processing, on the computer system, the speech interaction to detect a plurality of spoken phrases;
matching, on the computer system, a first spoken phrase of the spoken phrases with a corresponding phrase of the corresponding phrases of the first sales skill; and
identifying, on the computer system, a second sales skill of the sequence of sales skills after matching the first spoken phrase with the corresponding phrase of the first sales skill.

11. A method for generating an effective sequence of sales skills for an agent to utilize during an interaction, the method comprising:
applying, on a computer system comprising a processor and memory, a feature selection process to identify features from a plurality of feature vectors corresponding to a collection of successful historical interactions;
selecting, on the computer system, effective sales skills from the identified features; and
determining, on the computer system, an effective order of the effective sales skills.

12. A system comprising:
a processor; and
memory storing instructions configured to control the processor to:
recognize in real time a plurality of spoken phrases in a voice interaction;
detect a plurality of events from the spoken phrases;
identify a plurality of identified features corresponding to the detected events;
supply the identified features to a statistical model; and
identify, using the statistical model and the identified features, a recommended action from a plurality of actions.

13. The system of claim 12, wherein the identified features further comprise features corresponding to customer profile information.

14. The system of claim 12, wherein the recommended action comprises an offer of a particular product of a plurality of products.

15. The system of claim 12, wherein the statistical model comprises a trained neural network.

16. The system of claim 15, wherein the system is configured to generate the trained neural network using a collection of historical sales interactions by:
performing automatic speech recognition on the collection of historical sales interactions;
detecting historical events within the collection of historical sales interactions;
determining historical sales results of the historical sales interactions; and
training the trained neural network using the historical events and the historical sales results.

17. The system of claim 16, wherein the trained neural network is a multilayer perceptron neural network and wherein the neural network is trained by applying a backpropagation algorithm.

18. The system of claim 12, wherein the statistical model comprises a plurality of product statistical models, each product statistical model being configured to compute, based on the identified features, a probability of selling a corresponding product of a plurality of products, and
wherein the system is configured to identify the recommended action by:
supplying the identified features to each of the product statistical models of the statistical model to compute a plurality of probabilities corresponding to the products;
multiplying each of the computed probabilities by a corresponding product profit margin to compute expected values; and
identifying the recommended action in accordance with the expected values.

19. The system of claim 18, wherein the generating the recommended action comprises:
returning a recommended action of not offering any product when all of the expected values are below a threshold value; and
returning an identified product of a plurality of products, the identified product corresponding to a largest expected value of the expected values when not all of the expected values are below the threshold value.
